(19) United States
(12) Patent Application Publication
(10) Pub. No.: US 2006/0273549 A1
(43) Pub. Date: Dec. 7, 2006

(54) METHOD AND APPARATUS FOR ALIGNMENT OF A TRAILER HITCH

(76) Inventor: Dan L. Dietz, Houston, TX (US)

Correspondence Address: TUMEY, L.L.P., P.O. BOX 22188, HOUSTON, TX, 77227-2188, US

(21) Appl. No.: 11/160,037

(22) Filed: Jun. 6, 2005

(51) Int. Cl. B60D 1/36

(52) U.S. Cl. 280/477

(57) ABSTRACT

A trailer hitch alignment apparatus for use in assisting the driver of a towing vehicle to align a trailer hitch ball carried by said towing vehicle with a trailer hitch socket carried by a trailer. This apparatus includes a pair of guide member having magnetic bases for coupling with the towing vehicle and trailer, and having a visual indicator. This apparatus also includes an alert activated by a proximity switch.

### BACKGROUND OF THE INVENTION

1. Field of the Invention

The present invention relates to hitches. In another aspect, the present invention relates to hitches, and to methods, apparatus and products for engagement of hitches with trailers and the like.

2. Brief Description of the Related Art

For many years now vehicles that are temporarily connected to trailers have been used to transport boats, off-road vehicles, lawn maintenance equipment, and other vehicles. Generally, a hitch assembly connected to the towing vehicle and trailer is employed to permit their interconnection.

Standard trailer hitches commonly include a socket on the tongue of a trailer for connection with a ball mounted on the towing bar of the towing vehicle. Coupling of the ball and socket requires the driver of the motor vehicle to rearwardly maneuver the vehicle until the ball of the hitch is vertically aligned with the socket of the trailer. Without assistance, the driver typically has difficulty maneuvering the ball into position for engagement with the socket since the ball and socket are outside the driver's field of vision. Even with assistance, vertical alignment of the trailer hitch components may be a frustrating and time consuming task. Additionally, damage to the vehicle or trailer is a real possibility with such blind maneuvering.

For even experienced drivers, hookup requires much trial and error. Generally, the driver must back up slowly and repeatedly stop the vehicle and exit the vehicle to determine the new location of the hitch with respect to the trailer hitch so as to not damage the vehicle. This is undesirable for user's who utilize trailers often such as farmers. Hence, there is a need for a trailer hitch alignment system that allows a user to conveniently align a vehicle with a trailer hitch without the user having to exit the vehicle.

As would be expected, many devices have been put forth to solve this problem, dating back a number of years and extending to the present. Most such devices include a pair of co-operating visual aids, one secured to the trailer and the other secured to the towing vehicle, so that alignment of the hitch components may be made by maneuvering the vehicle from the driver's seat. Representative of these are U.S. Pat. Nos. 3,918,746, 4,285,138 and 4,065,147. Most of these devices are either impractical, easily damaged, or prohibitively expensive. Some hitching assemblies have complicated pivoting components and mechanical guiding members permitting less precise positioning of the vehicle by the operator. (U.S. Pat. Nos. 2,197,157 and 2,844,390)

Other devices recognize the shortcomings of all of the line of sight devices, and provide for “blind” coupling, depending upon electronic sensors, signal transmitters and the like.

Many of these devices, however, are electromechanical, in that some physical connection between the towed and the towing vehicle is necessary. U.S. Pat. No. 4,030,775 utilizes a spool of wire with a micro-switch connected to a display to show how much of the wire is extended or retracted, which indicates relative coupling positions of the hitch components. Similarly, U.S. Pat. No. 4,432,563 utilizes a wire, with the added provision for indication of the direction of deviation of the wire from axial alignment as the towing vehicle maneuvers. Other patents utilizing a combination of electronics, display, and switching devices include U.S. Pat. No. 2,797,406 (hitch contact switches carried by towing vehicle), U.S. Pat. No. 3,418,628 (position switches tripped by ball) and U.S. Pat. No. 4,187,494 (flexure of a member utilized as a sensing means for indication of relative angular and linear positions). U.S. Pat. No. 3,825,921 utilizes a wave emitter on the towing vehicle and a wave receiver coil on the trailer. A current is induced in the coil, which is monitored to show relative positions of the emitter and receiver coils. The physical connection between the towing and the towed vehicles is in this case an electrical conductor. However, a considerable number of components and electrical controls are necessary.

In contrast, U.S. Pat. No. 3,924,257 issued Dec. 2, 1975, to Roberts, employs no mechanical connection between the trailer and towing vehicle. The '257 patent discloses a trailer hitch guidance system for assisting the operator of a towing vehicle, during the backing of the later, provides a transmitter on the vehicle to be towed and a receiver on the towing vehicle which receives a signal from the transmitter and detects from the amplitude and the polarity of the respective coordinate signals generated thereby, the direction and proximity of the towing vehicle with respect to the towed vehicle.

U.S. Pat. No. 4,192,526, issued Mar. 11, 1980, to Myers, discloses a hitch guide assembly comprising a target post vertically positioned above a socket member of a towed vehicle and sighting means vertically positioned above a ball member of a towing vehicle. The sighting means comprises a V-shaped mounting bracket which magnetically couples to the towing vehicle and has an extension arm pivotally attached to the mounting bracket. The sighting means further includes a guide pointer which may be selectively positioned along the extension arm so that, when combined with the pivoted adjustment of extension arm, the outer end portion of the guide pointer is substantially positioned over the coupling member of the towing vehicle.

U.S. Pat. No. 4,285,138, issued Aug. 25, 1981, to Berry, discloses aligning devices for aligning a towing vehicle with a trailer wherein the towing vehicle has a ball and the trailer vehicle a socket carrying arm. A pair of magnetic bases having vertically positionable wands are placed one on the towing vehicle and one on the trailer. Each wand has an elastic gromet slidable along its length for retaining a signal flag on its upper side and to permit passage between the wand and the gromet of a plumb line. There are two plumb lines and two plumb bobs which when the lines are vertical and the two plumb bobs positioned immediately above the ball and the trailer socket, the alignment flags will be horizontal so that when the vehicle is backed toward the trailer unit the flags cross then hookup can be effectuated.

U.S. Pat. No. 4,723,788, issued Feb. 9, 1988, to Suter, discloses an apparatus for facilitating the alignment of a trailer hitch socket with the ball mounted on the towing vehicle is provided wherein a couple of interfitting masts are used. The first mast mounts atop the socket on the trailer tongue and extends vertically upward high enough to the point which it is visible from the towing vehicle. The second mast has a collar to engage it on the ball of the trailer hitch attached to the towing vehicle. It also extends upwardly to a height at which it is visible from within the towing vehicle. As the vehicle backs up toward the trailer, the driver can see the two masts and steer such that they will come closer and closer together and finally nest together when the socket is directly over the ball.

U.S. Pat. No. 4,905,376, issued Mar. 6, 1990, to Neeley, discloses a hitch viewing mirror assembly detachably mounts directly to the tow vehicle, either a special tail-gate clamping means for a pick-up truck or a magnetic mount for a passenger car, thus the tow view operator may view the two vehicle hitch member and the trailer hitch member while operating the tow vehicle during the coupling process thereby providing a particularly effective method of aligning the position of the hitch members.

U.S. Pat. No. 4,988,116, issued Jan. 29, 1991, to Evertson, discloses a trailer hitch positioning aid having a magnetic switching unit mounted upon the hitch ball and a corresponding permanent magnetic field unit secured to the socket of the hitch. The magnetic switches are mounted about the ball in a triangular pattern, while the magnetic field is in a “U” shape, so that closing of one or more of the magnetic switches indicates relative position of the hitch ball and socket. No physical connection is necessary between the trailer and the towing vehicle.

U.S. Pat. No. 5,035,441, issued Jul. 30, 1991, to Murray, discloses a visual aid to assist a driver in maneuvering a towing vehicle toward a trailer or other vehicle to be towed for precisely aligning the hitch components of the two vehicles. The device mounts only to the towed vehicle and includes an integral bumper member to protect the vehicles should the driver back too far. The device is adaptable to all conventional trailer hitch components and is simple and easy to use. It comprises a universal adaptor, a sighting mast and a strap for attaching the assembly to the towed vehicle. The mast can be mounted in the vertical position for viewing through the back window or at an angle to extend laterally past the side of the tow vehicle to allow the driver to view the mast even if rearward visibility is blocked through the rear window of a tow vehicle. The mast is disturbed from its rest position when the hitch components are aligned. The device is also designed such that it can be mounted to a vehicle to provide an early warning signal to the driver of closely approaching an object.

U.S. Pat. No. 5,108,123, issued Apr. 28, 1992, to Rubenzik, discloses a vehicle docking device includes a matrix of sensors arranged in a planar array of rows and columns spaced apart from one another. The matrix of sensors is mounted proximate the hitch ball of the towing vehicle in a horizontal plane. An activator is supported in a predetermined position relative to the towing hitch of the vehicle to be towed for activating one of the sensors closest thereto. The activator is positioned to be directed at the center point of the sensor matrix when the hitch ball is directly under the towing hitch. The sensor matrix is electrically coupled to a corresponding array of indicators disposed near the driver of the towing vehicle. Each indicator is associated with a corresponding sensor. By observing the array of indicators, the driver can determine whether the hitch ball and towing hitch are aligned, or in what direction correction is required.

U.S. Pat. No. 5,113,588, issued May 19, 1992, to Walston, discloses a trailer hitch alignment guide device, for a ball and socket hitch, wherein the guides can be mounted either to the rear or side, wherein the sighting elements on the guides are visually emblematic of the coupling elements, where one sighting element is isomorphic of the hitch ball and the other sighting element is isomorphic of the socket, and where the sighting elements are scribed with lines which visually amplify deviations from alignment.

U.S. Pat. No. 5,269,554, issued Dec. 14, 1993, to Law et al., discloses an alignment guide includes a plurality of guide assemblies, one of which is mounted to a trailer hitch ball and the other mounted to a trailer tongue, wherein the guides each include telescoping vertical leg members for alignment and communication relative to one another for the positioning of a trailer hitch tongue relative to an associated trailer ball.

U.S. Pat. No. 5,558,352, issued Sep. 24, 1996 to Mills, discloses a trailer hitch alignment device which allows the driver of a vehicle to align the hitch of the driven vehicle with that of its trailer with no aid from another individual. The invention utilizes two masts having acrylic flags attached thereto mounted upon the hitch components of the respective vehicles to provide visual reference points for the driver. The acrylic flags are bright in color which allow them to be sufficiently illuminated by the reverse lights of the towing vehicle during times of darkness, thereby making night-time hitch alignment possible. Each mast is mounted to a hitch component via a dome-shaped base having several magnets underneath. The magnets provide the attraction force necessary to mount the masts to the hitch components and the shape of the mounting bases provide the bases with the ability to mounted upon virtually any hitch configuration. The mountings are further secured through the use of velcro-type straps which extend from the mounting bases to the hitch components. This enhances stability and, therefore, performance, of the invention when alignment is required over rough terrain or high winds. The invention further has a swing arm offset bracket to allow for the mounting of the masts on towing vehicles having spare tires mounted on their rear.

U.S. Pat. No. 5,650,764, issued Jul. 22, 1997, to McCullough, discloses a visual aid for assisting a driver backing up a towing vehicle to a drawn vehicle. A visual display includes a flat screen upon which are depicted images in the form of silhouettes or like simulations of the respective vehicles. This effect is provided by partially and selectively illuminating the screen. A sensor is placed on at least one of the vehicles for detecting relative alignment therebetween and proximity thereof. The sensor generates a signal which controls the screen. The silhouettes are moved on the screen in proportion to the actual relationship of the two vehicles. In a preferred embodiment, the image of the towing vehicle is stationary, and the image of the drawn vehicle moves responsive to input from the sensor. The sensor may employ an emitting coil and an induction coil, or may be of the reflected energy type, such as radar and infrared radiation. The display control preferably comprises a microprocessor. The visual aid has an on-off switch, a proximity readout, and an alarm annunciating the presence of an object interposed between the tow vehicle and the draft vehicle.

U.S. Pat. No. 5,669,621, issued Sep. 23, 1997, to Lockwood, discloses a device for facilitating the alignment of a trailer hitch socket with the ball mounted on the towing vehicle is composed of a fixed sight member, a pivoting sight member, and a stop plate. The pivoting sight member mounts on the edges of the trailer tongue and extends vertically upward to the point which it is visible from the towing vehicle. The fixed sight member is magnetically attached to the towing vehicle and mounted adjacent the towing ball on the trailer hitch. The fixed sight member extends vertically upward to a height at which it is visible from within the towing vehicle. As the vehicle backs up toward the trailer, the driver can see the two sight members and steer such that they will come closer and closer together. When the socket is directly over the ball the pivoting sight member is actuated and signals the driver that alignment is achieved. The stop brace prevents the towing vehicle from colliding with the trailer hitch.

U.S. Pat. No. 5,680,706, issued Oct. 28, 1997, to Talcott, discloses a device for alignment of a trailer and a towing vehicle which consists of a visible mast placed on the trailer tongue to allow the towing vehicle driver to view the mast and to easily back into a correct position for coupling with the trailer. The mast has a pivotable arm which can be secured in either an extended contact position or a relaxed, downward position as necessary.

U.S. Pat. No. 5,729,194, issued Mar. 17, 1988, to Spears et al., discloses various configurations of components to provide for either informing an operator of a vehicle of relative positions of the vehicle and a stationary trailer during a backing procedure or informing the operator of an arrival at a hitchable position during the backing procedure. Three general embodiments are disclosed which include use of a magnetically activated switch, use of an autofocus assembly and use of a light reflective arrangement. Several possible combinations of the separate embodiments are explained which enhance the function of the assemblies to ensure proper positioning of the vehicle relative to the stationary trailer. Explanations of each embodiment are provided along with numerous variations to each. Each of the embodiments rely upon a component, or group of components, located on the vehicle which require a power source to operate. When it is a requirement that a component be placed upon the stationary trailer, that component does not require a source of power. An explanation of various modes of informing the operator of the feedback from the deployed components are presented. These include both audio feedback as well as visual feedback.

U.S. Pat. No. 5,821,852, issued Oct. 13, 1988, to Fairchild, discloses an apparatus for indicating axial alignment or deviation from alignment, and proximity between a tow vehicle and a trailer towards which the tow vehicle must be maneuvered. The apparatus comprises a storage reel mounted on the tow vehicle for storing and paying out a cord, a pulley having a magnet for mounting the pulley temporarily on the trailer hitch, and a take up reel mounted on the tow vehicle for applying tension to the cord. As the tow vehicle is maneuvered, changes in relative position between tow vehicle and trailer cause the cord to change length and angular orientation relative to the tow vehicle. These changes are sensed as one or both of the storage reel and take up reel rotate responsive to cord changes. A plurality of switches make or break contact to a matrix of indicating lamps located in the cabin of the tow vehicle, the indicating lamps indicating position of the tow vehicle relative to the trailer. The reels are permanently or temporarily mounted on the tow vehicle. The pulley has a magnet for temporary, readily removable attachment to the trailer hitch.

U.S. Pat. No. 5,861,814, issued Jan. 19, 1999, to Clayton, discloses a new trailer hitch with sensor system for allowing for easier alignment for coupling with a trailer. The inventive device includes a hitch portion secured to a rear portion of a towing vehicle. The hitch portion has an upper ball portion. The upper ball portion has a pair of sensors disposed therein. Each of the sensors are connected to a central wire. The central wire extends interiorly of the vehicle. A trailer tongue extends outwardly from a trailer. The trailer tongue has a ball socket formed within a free end thereof. The ball socket is dimensioned for receiving the upper ball portion of the hitch portion therein. The ball socket has a magnet disposed therein for being sensed by the sensors of the upper ball portion. A display box is positioned interiorly of the vehicle. The display box is in communication with the central wire of the pair of sensors. The display box provides signals related to a proximity of the trailer tongue to the hitch portion.

U.S. Pat. No. 5,951,035, issued Sep. 14, 1999, discloses a trailer hitch alignment system which includes an alerting device and a tow bar assembly for attachment to a towing vehicle. The tow bar assembly includes a photoelectric sensor for detecting the vertical alignment of a trailer tongue. The tow bar assembly has a hitch ball with a spherical top and a cylindrical body for coupling with a trailer tongue having a semi-spherical socket. In one embodiment, the photoelectric sensor is mounted on the tow bar of the tow bar assembly, adjacent to the hitch ball. In another embodiment, the hitch ball houses the photoelectric sensor within its interior. During operation, the driver of the towing vehicle typically maneuvers the vehicle toward the trailer in a rearward direction. Once the photoelectric sensor detects the vertical alignment of the socket with the ball, the alerting device is activated informing the driver of the alignment.

U.S. Pat. No. 6,100,795, issued Aug. 8, 2000, to Otterbacher et al., discloses a trailer hitch alignment system for allowing a user to easily align a hitch of a vehicle with a trailer hitch. The inventive device includes a control that is mountable to a visor of the vehicle in view of the driver, a receiver unit attachable to the bumper of the vehicle and in communication with the control unit, a transmitter unit removably attachable to a trailer hitch that transmits a locating signal that is detectable by the receiver unit, and a storage case. Electronic circuitry within the control unit determines the position of the transmitter unit from the receiver unit from the reception of the locating signal. The control unit includes a turn right indicator and a turn left indicator for visually indicating to the user whether to turn left or right while backing toward the conventional trailer. The control unit also includes a buzzer and stop indicator light for indicating to the user when the ball hitch is positioned below the coupler of the trailer hitch. The control unit also includes a display screen that visually indicates the position of the vehicle with respect to the trailer hitch. If the user needs to turn left or right, either the turn left indicator or the turn right indicator will display various levels of lights indicating to the user that they must turn appropriately for proper alignment of the vehicle with the conventional trailer.

U.S. Pat. No. 6,222,457, issued Apr. 24, 2001, to Mills et al., discloses a trailer hitching system and method is provided for facilitating an operator's maneuvering of a towing vehicle hitch component into alignment with a towed vehicle hitch component to enable mechanical interconnection of the hitch components. The trailer hitching system includes an alignment sensor attached to either the towing vehicle or the towed vehicle for emitting a light beam over a field of view. A reflector attached to the other of the towing vehicle or the towed vehicle is mounted at a predetermined location relative to the alignment sensor. The reflector reflects a portion of the light beam emitted from the alignment sensor. An alarm in the alignment sensor emits an audible alarm in response to detecting a portion of the reflected light beam. The activation of the audible alarm indicates that the reflector is within the field of view of the alignment sensor and thereby the hitch components are moving towards alignment.

U.S. Pat. No. 6,341,794, issued Jan. 29, 2002, to Hunter, discloses a trailer hitch alignment apparatus comprising a first guide member removably attached to a vehicle bumper and a second guide member removably attached to a trailer hitch socket. The first guide member includes a magnetic base with a telescopically extensible rod adjustably coupled thereto. The second guide member includes a magnetic base having an upwardly extending telescopic rod and a downwardly extending semi-flexible shaft attached thereto. The shaft extends downwardly through a bore defined by the trailer hitch tongue so as to contact the trailer hitch ball when the ball and socket are aligned. Contact between the shaft and ball causes vertical displacement of the shaft and guide rod. Therefore, the two telescopic guide rods, visible from a driver's seat, facilitates lateral alignment of the ball and socket while vertical displacement of the second rod indicates perfect forward alignment.

U.S. Pat. No. 6,612,603, issued Sep. 2, 2003, to Alger, discloses a trailer hitch alignment hitch system uses height adjustable stanchions with length adjustable arms terminating in mirrors. The stanchions are respectively connectible to a tow vehicle and a trailer and placed so that the mirror is aligned vertically over the hitch connection component of the tow vehicle and the trailer and adjusted so that the respective mirrors are at different heights. The tow vehicle operator backs the tow vehicle until the mirrors visually indicate vertical alignment by one mirror coming into place below the other mirror and obstructing the view of the hitch component.

U.S. Pat. No. 6,517,098, issued Feb. 11, 2003, to Grasso et al., discloses an alignment device to align a vehicle's trailer hitch ball neck assembly with a trailer hitch socket assembly or tongue assembly. The invention includes two units, each having uprights with engaging press on members. The ball neck upright member has a “C”-shaped bottom portion for frictionally engaging the neck of the trailer hitch ball neck, and the hitch engaging upright member has a “U”-shaped bottom portion for frictionally engaging the outer housing of the hitch socket member around its lower end periphery. When used in conjunction with each other, the two poles visually assist the vehicle operator in aligning the vehicles so that they may be easily coupled together for towing.

U.S. Pat. No. 6,454,290, issued Sep. 24, 2002, to Turner, discloses a trailer hitch alignment device has a base block for placement on the coupler of a trailer. The block has a magnet at its bottom for being connected to the coupler and a series of apertures directed at varying angles to receive an upright post inclined at a selected angle. A cross arm extending generally horizontally is connected to the post in a manner such as to allow adjustments in vertical and horizontal directions. The post-to-cross arm connection has pair of block members through which the post and cross arm pass and a spring biasing the members together.

U.S. Pat. No. 6,712,378, issued Mar. 30, 2004, to Austin, discloses a trailer hitch alignment device is provided having a hitch alignment guide and a ball target mast. The hitch alignment guide has a vertically disposed, elongated alignment mast affixed to a magnetic, disc shaped hitch base. The ball target mast is composed of a vertically disposed, elongated alignment mast affixed to a magnetic, ring shaped ball base. The masts are telescoping shafts having linearly spaced alignment indicia are provided in a linearly spaced manner along the upper portion of the shafts.

U.S. Pat. No. 6,765,607, issued Jul. 20, 2004, to Mizusawa et al., discloses a driving aiding system for displaying a picked-up image of a rear-view camera equipped onto a rear portion of a vehicle on a screen of a displaying means arranged at a position which can be viewed from a driver's seat when the vehicle is to be backed, a locus estimated line of a hitch which is equipped onto a rear portion of the vehicle is superposed on the picked-up image of the rear-view camera to display when a predetermined instruction input is received.

U.S. Pat. No. 6,827,363, issued Dec. 7, 2004, to Amerson, discloses an alignment apparatus for assisting a driver in directing coupling engagement between a towing vehicle hitch and a trailer hitch. The apparatus includes a guide carried by the towing vehicle representing the position of the towing vehicle hitch for being visible to the driver. A target is carried by the trailer representing the position of the trailer hitch for being visible to the driver. The target has a pair of laterally spaced posts defining a target zone for receiving the guide to align the towing vehicle hitch with the trailer hitch for coupling engagement. A sensor is carried by the guide for determining whether the guide is within the target zone. An indicator is operatively associated with the sensor for indicating to the driver when the guide is within the target zone to alert the driver of alignment between the towing vehicle hitch and the trailer hitch for coupling engagement.

In spite of the many advancements in the art of trailer hitches and the coupling of such hitches with a trailer, there exists a need in the art for improved apparatus, methods and products for coupling a hitch and trailer.

This and other needs in the art will become apparent to one of skill in the art upon review of this specification, including its drawings and claims.

### SUMMARY OF THE INVENTION

It is an object of the present invention to provide for improved apparatus, methods and products for coupling a hitch and trailer.

This and other objects of the present invention will become apparent to one of skill in the art upon review of this specification, including its drawings and claims.

According to one embodiment of the present invention, there is provided a trailer hitch alignment apparatus for use in assisting the driver of a towing vehicle to align a trailer hitch ball carried by said towing vehicle with a trailer hitch socket carried by a trailer. The alignment apparatus includes a first guide member comprising (i) a first base adapted to be removably coupled to said towing vehicle, and (ii) a first guide rod coupled to said first base, said first guide rod comprising a first visual indicator. The apparatus also includes a second guide member comprising (i) a second base adapted to be removably coupled to the trailer, and (ii) a second guide rod coupled to said second base, said second guide rod comprising a second visual indicator. Finally, at least one of the first and second guide members comprises an alert generating member.

According to another embodiment of the present invention, there is provided a trailer hitch alignment apparatus for use in assisting the driver of a towing vehicle to align a trailer hitch ball carried by said towing vehicle with a trailer hitch socket carried by a trailer. The alignment apparatus includes a first guide member comprising (i) a first base removably coupled to said towing vehicle, and (ii) a first guide rod coupled to said first base, said first guide rod comprising a first visual indicator. The apparatus also includes a second guide member comprising (i) a second base removably coupled to the trailer, and (ii) a second guide rod coupled to said second base, said second guide rod comprising a second visual indicator. Finally, at least one of the first and second guide members comprises an alert generating member.

According to even another embodiment of the present invention, there are provided methods of backing utilizing the apparatus as described above and below.

These and other embodiments of the present invention will become apparent to one of skill in the art upon review of this specification, including its drawings and claims.

### BRIEF DESCRIPTION OF THE DRAWINGS

In the drawings, it should be understood that like references numbers refer to like elements.

FIG. 1 is an illustration showing backing apparatus 100, comprising a pair of visual guide posts 200 and 300, mounted on vehicle 215, each visual guide post comprising a mounting member 108, support member 183, and a visual indicator 127.

FIGS. 3, 4 and 2, are respectively, top view, side view, and section A-A of FIG. 3, showing visual guide post 200 of FIG. 1, comprising a mounting member 108, support member 183, and a visual indicator 127.

FIGS. 5, 6 and 7, are respectively, top view, side view, and section A-A of FIG. 6, showing visual guide post 300 of FIG. 1, comprising a mounting member 108, support member 183, and a visual indicator 127.

### DETAILED DESCRIPTION OF THE INVENTION

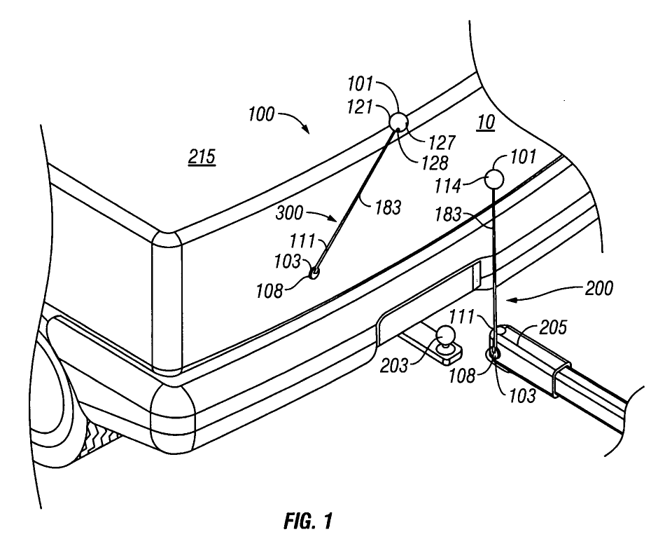

The present invention is most easily described by reference to the drawings. Referring first to FIG. 1, there is shown an illustration of backing apparatus 100, comprising a pair of visual guide posts 200 and 300, mounted on vehicle 215, each visual guide post comprising a mounting member 108, support member 183, and a visual indicator 127.

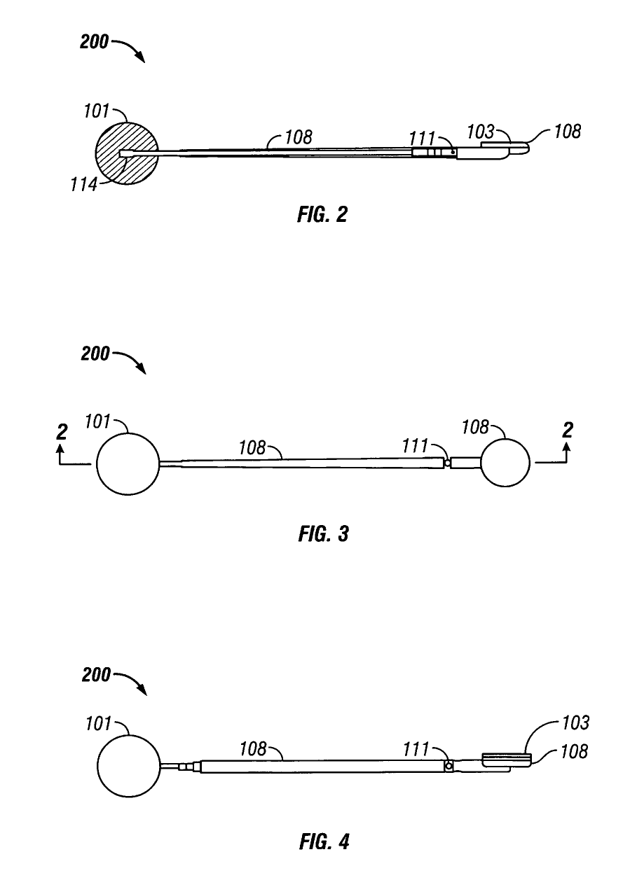

Additional details regarding visual guide post 200 may be found in FIGS. 3, 4 and 2, which are respectively, top view, side view, and section A-A of FIG. 3, showing visual guide post 200 of FIG. 1, comprising a mounting member 108, support member 183, and a visual indicator 127.

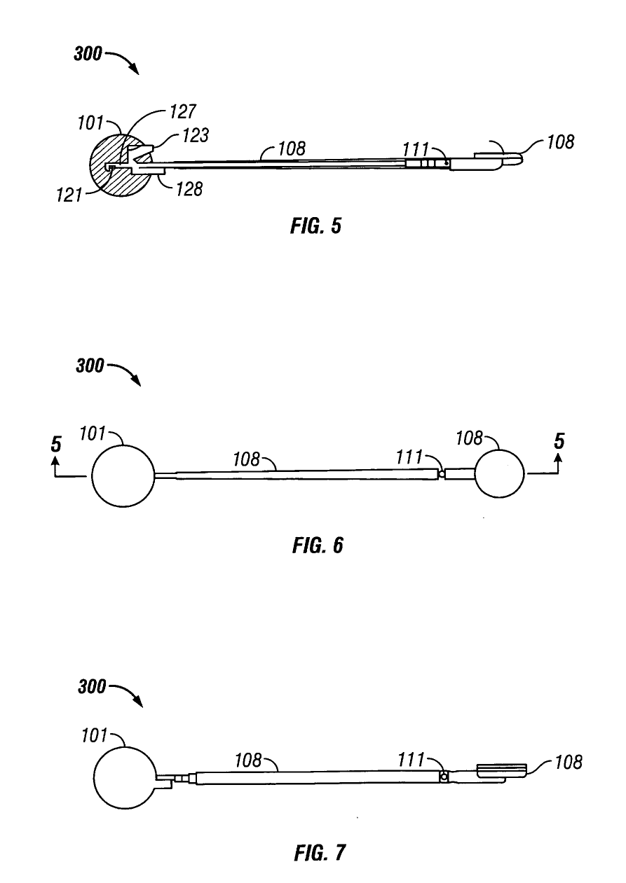

Additional details regarding visual guide post 300 may be found in FIGS. 5, 6 and 7, which are respectively, top view, side view, and section A-A of FIG. 6, showing visual guide post 300 of FIG. 1, comprising a mounting member 108, support member 183, and a visual indicator 127.

Both guide post 200 and guide post 300 comprise a mounting member 108, which serves to anchor the guide posts 200 and 300 respectively to trailer hitch 205 or to vehicle 215 utilizing any suitable means. Support bracket 108 may be relatively permanently mounted, non-limiting examples of which include use of bonding materials, adhesives, screws, bolts, brackets, fasteners, or may be removeably mounted, non-limiting examples of which include friction fit fasteners, quick release brackets, bracket docking systems, hook and loop fastener systems (for example, those sold under the brandname VELCRO), or as preferred and shown herein by magnetic coupler 103. It is also possible to make the visual guide posts integral with vehicle 215 or hitch 205.

The beauty of using a quick release mounting system such as magnet coupler 103, is that it allows for quick installation of backing system 100 in anticipation of backing, and then for quick removal (and subsequent storage) of backing system 100 upon completion of the backing operation.

Support member 183 may be any suitable shape, and is preferably an elongated shape, most preferably a rod shape. In the embodiment as shown, support member 183 is telescoping to allow for positioning of visual guides 101. Support member 183 could also comprise any type of accordion shaped member, retractable or foldable member, which would allow for positioning of visual guides 101. Support member 183 may be provided one or more swivel joints 111 to allow for further positioning of visuals guides 101.

Both visual guide posts 200 and 300 comprise visual guides 101. These visual guides 101 may comprise indicia on support members 183 such as stripes, hatchings, markings, patterns or colorings, or as is shown in the figures, may comprise a portion with distinct shape from support members 183.

These visual guides 101 are observed by the driver during the backing operation. Thus, it is desired that visual guides 101 comprises one or more contrasting colors to be readily visible, most preferably fluorescent, even more preferable glow in the dark fluorescent. Visual guides 101 may be the same or different color, preferably they are different colors which are highly contrasting relative to the environment and each other. Of course, these visual guides 101 may comprise indicia stripes, hatchings, markings, patterns or colorings.

Visual guides 101 are generally any suitable shape which may be easily viewed by the driver during the backing operation. Any thin or planar shapes have the possibility of being oriented to present a thin face toward the driver, and thus be more difficult to view. It is generally desired to utilize a visual guide having a shape that will appear to remain constant to the driver, no matter the orientation of the guide 101, thus allowing for easy installation (without concern for positioning). In the embodiment as shown, guide 101 has a spherical shape.

On the other hand, it is possible to utilize a relatively flat shape for guide 101 on the trailer which will “disappear” when backing directly in line with the guide, and which will “appear” when backing off line, to allow a driver to correct as the guide “appears.” As a further embodiment, this guide 101 on the trailer may be designed to present two faces of different colors when backing directly in line, but shaped such that one color will disappear when the backing is too much offline, and perhaps even reveal a third color. For example, a pentagon, hexagon or other suitable polygon shape. Of course, this type of embodiment presents a more difficult mounting problem as guide 101 must be correctly oriented.

In another embodiment, guide 101 positioned on the trailer may be larger than guide 101 positioned on the vehicle, with the idea being to back the vehicle in such a manner so that from the line of sight of the driver (either over the shoulder or thru the rear view mirror) the guide on the vehicle appears to stay “within” the perimeter of the guide on the trailer. Alternatively, the guide on the vehicle could be larger, with the idea being to back the vehicle in such a manner that the larger guide on the vehicle “eclipses” the smaller guide on the trailer, thus keeping the guide on the trailer obscured from the line of sight of the driver.

As another embodiment, the guide 101 on the vehicle could comprise a portion that allows for visual sighting thru the guide, either because it is made of transparent material, or because material is lacking (for example a doughnut shape), to view the guide 101 on the trailer. With such an embodiment, the idea is to back the trailer in such a manner as to keep the trailer guide within the visual sighting portion as viewed from the line of sight of the driver.

While the guides 101 may be positioned by any suitable manner, most conveniently, to arrive at the same height for each guide 101, the operator should make reference by comparing the guides to some point on the operator's body/clothing and adjust each guide 101 to be situated at approximately the same height.

Backing apparatus 100 is further equipped with a proximity switch, such that upon a certain proximity of guide posts 200 and 300 to each other, an alert, whether audio, visual, vibratory, or other type of alert, is provided. To provide an alert, the proximity switch will change of the condition of the audio, visual, vibratory or other alert. As a non-limiting example, if the alert was on it will turn it off, turn it off if it was on, make it intermittent if it was constant, make it constant if it was intermittent, change the magnitude of the alert, change the frequency of the alert, or change the pattern of the alert.

This proximity switch will operate depending on the distance between guide posts 200 and 300, and it can be configured to turn on/off (or off/on) based on whether guide posts 200 and 300 are within a certain threshold distance or not, or the proximity switch can be made to operate in rheostat fashion as the distance between the guide posts varies.

This alert is may positioned to occur in the vehicle cabin, or occur outside the vehicle cabin but be observable inside the cabin. In the embodiment as shown one visual guide 101 is provided with a light 121 and a magnet activated switch 127, with the other visual guide 101 provided with a magnet 114. Upon a certain approach of guide post 200 to guide post 300, magnet 114 trips magnet activated switch 127 to turn on light 127. This light 127 will all for a visual alert even during the night.

Of course, one or both of visual indictors 101 may be equipped with a light that provides constant or intermittent lighting during the backing operation. In such an embodiment, to indicate proximity of the indicators 101, switch 127 may be activated by magnet 114 to change the operation of such a light (i.e., going from constant to blinking, going from blinking to constant, going to a different blinking pattern), or even activating a different light or other alert).

In operation, backing apparatus 100 is affixed to the vehicle and trailer such that visual guides are located generally above the trailer ball 203 and the trailer tongue 205. In a backing operation, once the driver maneuvers vehicle 215 close enough to trailer 218, magnet 114 trips magnet activated switch 127 to turn on light 121 to give an indication the trailer tongue and hitch are located close to each other. The driver will view visual guides 101 and back up attempting to position visual guides 101 close to each other.

Once the driver maneuvers vehicle 215 close enough to trailer 218, the driver will exit vehicle 215 and go to the rear of vehicle 215 to secure trailer hitch 203 and trailer tongue 205, hook up safety chains, and perhaps even make electrical connections between vehicle 215 and trailer 218. In the dark, this might require a flashlight or other light source. The present invention anticipates manual operation of switch 128 to turn on light 123 and thereby provide light for this securing operation.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains. Additionally, it should be understood that not all of the inventions described herein have been incorporated into the claims as originally filed, and that claims may be later added directed to other inventions described herein.

All patents and publications cited herein are hereby incorporated by reference for all that they teach and suggest.

What is claimed is:

1. A trailer hitch alignment apparatus for use in assisting the driver of a towing vehicle to align a trailer hitch ball carried by said towing vehicle with a trailer hitch socket carried by a trailer, said alignment apparatus comprising:
a first guide member comprising (i) a first base adapted to be removably coupled to said towing vehicle, and (ii) a first guide rod coupled to said first base, said first guide rod comprising a first visual indicator;
a second guide member comprising (i) a second base adapted to be removably coupled to the trailer, and (ii) a second guide rod coupled to said second base, said second guide rod comprising a second visual indicator;
wherein at least one of the first and second guide members comprises an alert generating member.

2. The apparatus of claim 1, wherein the at least one of the first base and the second base comprise a magnet, wherein at least one of the first and second guide rods are telescoping, and wherein the alert generating member comprises a light.

3. The apparatus of claim 2 wherein the first and second visual indicators are spherically shaped, wherein each indicator comprises a different glow in the dark fluorescent color.

4. The apparatus of claim 1, further comprising a proximity switch to change the condition of the alert depending on a distance between the first guide member and the second guide member.

5. The apparatus of claim 4, wherein the at least one of the first base and the second base comprise a magnet, wherein at least one of the first and second guide rods are telescoping, and wherein the alert comprises a light.

6. The apparatus of claim 5, further comprising a work light positioned to direct light at the trailer hitch ball or the trailer hitch socket.

7. The apparatus of claim 1, further comprising a work light positioned to direct light at the trailer hitch ball or the trailer hitch socket.

8. A trailer hitch alignment apparatus for use in assisting the driver of a towing vehicle to align a trailer hitch ball carried by said towing vehicle with a trailer hitch socket carried by a trailer, said alignment apparatus comprising:
a first guide member comprising (i) a first base removably coupled to said towing vehicle, and (ii) a first guide rod coupled to said first base, said first guide rod comprising a first visual indicator;
a second guide member comprising (i) a second base removably coupled to the trailer, and (ii) a second guide rod coupled to said second base, said second guide rod comprising a second visual indicator;
wherein at least one of the first and second guide members comprises an alert.

9. The apparatus of claim 8, wherein the at least one of the first base and the second base comprise a magnet, wherein at least one of the first and second guide rods are telescoping, and wherein the alert generating member comprises a light.

10. The apparatus of claim 9 wherein the first and second visual indicators are spherically shaped.

11. The apparatus of claim 8, further comprising a proximity switch to change the condition of the alert depending on a distance between the first guide member and the second guide member.

12. The apparatus of claim 11, wherein the at least one of the first base and the second base comprise a magnet, wherein at least one of the first and second guide rods are telescoping, and wherein the alert comprises a light.

13. The apparatus of claim 12, further comprising a work light positioned to direct light at the trailer hitch ball or the trailer hitch socket.

14. The apparatus of claim 8, further comprising a work light positioned to direct light at the trailer hitch ball or the trailer hitch socket.
